(19) United States
(12) Patent Application Publication
(10) Pub. No.: US 2021/0334428 A1
(43) Pub. Date: Oct. 28, 2021

(54) METHOD FOR PREDICTION OF DYNAMIC RESCHEDULING WITH DIGITAL TWIN WORKSHOP FOR CIRCUIT BREAKER AND SYSTEM USING THE SAME

(71) Applicant: Technology Institute of Wenzhou University, Yueqing, Wenzhou (CN)

(72) Inventors: Liang Shu, Wenzhou (CN); Yanfang Yang, Wenzhou (CN); Miao Yang, Wenzhou (CN); Dingfang Chen, Wenzhou (CN); Shasha Li, Wenzhou (CN); Zhenquan Lin, Wenzhou (CN); Guichu Wu, Wenzhou (CN); Xiangou Zhu, Wenzhou (CN)

(21) Appl. No.: 17/015,032

(22) Filed: Sep. 8, 2020

(30) Foreign Application Priority Data
Apr. 24, 2020 (CN) 202010330590.X

(51) Int. Cl. G06F 30/18

(52) U.S. Cl. CPC G06F 30/18; G06F 2111/10

(57) ABSTRACT

A method for prediction of dynamic rescheduling with a digital twin workshop for circuit breakers includes: building a circuit breaker digital manufacturing twin workshop system; determining a circuit breaker circuit breaker workshop dynamic rescheduling mathematical model that is based on rush order events, and performing prediction of information related to the rush order events on twin data of the circuit breaker digital manufacturing twin workshop system based on a prediction mechanism that relies on time window setting and order inquiry, and further updating the circuit breaker workshop dynamic rescheduling mathematical model with the predicted information related to the rush order events; and based on the updated circuit breaker workshop dynamic rescheduling mathematical model, developing a workshop dynamic rescheduling prediction model for multi-objective optimization focused on production efficiency and equipment energy consumption, and further finding an optimal solution to the workshop dynamic rescheduling prediction model using a multi-objective backtracking optimization algorithm, thereby obtaining a final dynamic rescheduling prediction scheme.

### BACKGROUND OF THE INVENTION

### 1. Technical Field

The present invention relates to digital modeling for workshops manufacturing circuit breakers, and more particularly to a method for prediction of dynamic rescheduling with a digital twin workshop for circuit breakers and a system using the method.

### 2. Description of Related Art

Circuit breakers are important protective equipment in power distribution systems and have been extensively used in various aspects of the national economy, such as electricity, petroleum, chemistry, engineering and so on. With such protective features, circuit breakers play an important role in maintaining stability of the grid and in securing people and property. Generally, circuit breaker manufacturers make production in batch, and this practice is advantageous as it provides fast production, high quality and good consistency. However, depending on technologies and processes, batch production of finished circuit breakers involves a long, 30-step workflow, which includes material feeding, magnetic/thermal systems welding, assembling, transient/delay property testing, visual inspection and more. In case of dynamic events such as rush orders or cancellation, issues like slow response, poor efficiency, and disordered production can raise, making it necessary to optimize production by developing and executing issue-specific dynamic rescheduling prediction schemes.

There are three types of dynamic scheduling currently used in workshops, namely robust scheduling, complete response scheduling, and rescheduling. Robust scheduling is made with full consideration to dynamic events that are likely to happen during production, thereby generating a scheduling scheme with robustness of a certain level. Complete response scheduling is to make real-time scheduling based on the current state of the system and local information, and is also known as online scheduling or real-time scheduling. Rescheduling is about modifying and redoing a set scheduling scheme according to a predetermined drive-response mechanism, so as to deal with dynamic disturbing factors.

While the foregoing scheduling methods are effective to some extent, they are all post-even approaches. To be specific, these known approaches can only deal with a dynamic event through data collection, calculation and feedback and re-schedule production after that dynamic event happens. Since operations like data collection, calculation and feedback are time-consuming, these known approaches are relatively inefficient when it comes to scheme making and thus are less capable of addressing real-time issues in a way adaptive to the current state of the workshop and production arrangements, thus being imperfect in terms of development and execution of rescheduling schemes. Particularly, for workshops implementing batch production where production state is always changing, the inefficient scheme making and low timeliness become even more limiting to production optimization.

Hence, there is a need for a workshop dynamic rescheduling prediction method applicable to a digital manufacturing twin workshop of circuit breakers for more efficient rescheduling in a circuit breaker workshop as response to dynamic rush order events, thereby optimizing production.

### SUMMARY OF THE INVENTION

The objective of the present invention is to provide a method for prediction of dynamic rescheduling with a digital twin workshop for circuit breakers and a system using this method, which deals with disturbing events like dynamic rush orders in a proactive manner, thereby improving rescheduling efficiency and optimizing production.

For achieving the foregoing objective, the present invention embodiment provides a method for prediction of dynamic rescheduling with a digital twin workshop for circuit breakers, which comprises steps of:

Step S1: performing multi-granularity mapping, movement control and scene optimization on a circuit breaker workshop, and building a circuit breaker digital manufacturing twin workshop system;

Step S2: determining a circuit breaker workshop dynamic rescheduling mathematical model that is based on rush order events, predicting times and contents of the rush order events according to real-time twin data provided by the circuit breaker digital manufacturing twin workshop system based on a prediction mechanism that relies on time window setting and order inquiry, and further updating the circuit breaker workshop dynamic rescheduling mathematical model with the predicted times and content of the rush order events; and

Step S3: based on the updated circuit breaker workshop dynamic rescheduling mathematical model, using a multi-objective backtracking optimization algorithm, together with a random key encoding and plug-in decoding method, efficiently finding a solution to the circuit breaker workshop dynamic rescheduling mathematical model in a distributed computing platform, thereby obtaining an optimal dynamic rescheduling prediction scheme.

Therein, the step of performing multi-granularity mapping, movement control and scene optimization on a circuit breaker workshop is achieved by:

performing workshop geometric texture modeling, workshop hierarchy modeling, workshop equipment action modeling, workshop semantic modeling, workshop movement control and workshop scene optimization for the circuit breaker workshop.

Therein, the circuit breaker workshop dynamic rescheduling mathematical model based on the rush order events is generated through automatic update based on a predefined circuit breaker workshop production dynamic scheduling rule, in which

the circuit breaker workshop production dynamic scheduling rule includes: generating and executing an initial scheduling scheme first, if one said rush order event arrives or a future more optimal scheduling scheme is found, decoding and executing a corresponding rescheduling scheme, and further re-performing rescheduling prediction; and if no said rush order events arrive or no future more optimal scheduling schemes are found, performing corresponding rescheduling prediction based on variation of prediction time sections in a time window, until production operation in the workshop stops.

Therein, the times of the rush order events are predicted based on the time window setting, and the contents of the rush order events are predicted based on the order inquiry.

Therein, the time window setting is achieved by:

dividing operation time of the circuit breaker workshop into plural prediction time sections, and acquiring all the prediction time sections in a given future time period during real-time operation for production of the circuit breakers as times at which dynamic rush order events happen.

Therein, the order inquiry is achieved by:

checking all normal order events that are likely to cut in in the future, generating n+1 states including a “no new order cut in” state and “new order cut in” states for new orders J₁˜Jₙ in which the no new order cut in state is for real-time optimization of subsequent production operation in the workshop when there is an absence of said rush orders, and the new order cut in state is for optimization prediction of the rescheduling scheme after each said order event cuts in.

The present invention further provides a system for prediction of dynamic rescheduling with a digital twin workshop for circuit breakers, which comprises a workshop system building unit, a mathematical model developing and updating unit, and a dynamic rescheduling scheme solution-finding unit,

the workshop system building unit, serving to perform multi-granularity mapping, movement control and scene optimization on a circuit breaker workshop, and building a circuit breaker digital manufacturing twin workshop system;

the mathematical model developing and updating unit, serving to determine a circuit breaker workshop dynamic rescheduling mathematical model based on rush order events, to predict times and contents of the rush order events according to real-time twin data provided by the circuit breaker digital manufacturing twin workshop system based on a prediction mechanism that relies on time window setting and order inquiry, and to further update the circuit breaker workshop dynamic rescheduling mathematical model according to the predicted times and contents of the rush order events; and

the dynamic rescheduling scheme solution-finding unit, serving to efficiently find a solution to the circuit breaker workshop dynamic rescheduling mathematical model in a distributed computing platform based on the updated circuit breaker workshop dynamic rescheduling mathematical model, using a multi-objective backtracking optimization algorithm, together with a random key encoding and plug-in decoding method, thereby obtaining an optimal dynamic rescheduling prediction scheme.

Therein, the circuit breaker workshop dynamic rescheduling mathematical model based on the rush order events is generated through automatic update based on a predefined circuit breaker workshop production dynamic scheduling rule.

Therein, the times of the rush order events are predicted based on the time window setting, and the contents of the rush order events are predicted based on the order inquiry.

By implementing embodiments of the present invention, the following beneficial effects are expected:

The present invention uses a workshop rescheduling prediction mechanism based on time window setting and order inquiry to predict times and contents of dynamic rush order events that are likely to happen in the future, and employs a proactive method to deal with rush order events by performing dynamic rescheduling prediction of the circuit breaker digital manufacturing twin workshop, for more efficient rescheduling in a circuit breaker workshop as response to dynamic rush order events, thereby optimizing production.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a flowchart of a method for prediction of dynamic rescheduling with a digital twin workshop for circuit breakers according to the present invention embodiment;

FIG. 2 is a flowchart for building a digital manufacturing twin workshop for circuit breakers according to Step S1 in FIG. 1;

FIG. 3 is a flowchart of a circuit breaker workshop production rule according to Step S2 in FIG. 1;

FIG. 4 is a flowchart of circuit breaker workshop dynamic rescheduling prediction mechanism according to Step S2 in FIG. 1;

FIG. 5 is a schematic drawing illustrating time prediction based on time window setting according to Step S2 in FIG. 1;

FIG. 6 is a schematic drawing illustrating content prediction based on order inquiry according to Step S2 in FIG. 1;

FIGS. 7a-7g are applied views of a method for prediction of dynamic rescheduling with a digital twin workshop for circuit breakers according to one embodiment of the present invention; and

FIG. 8 is a schematic structural diagram of a system for prediction of dynamic rescheduling with a digital twin workshop for circuit breakers according to one embodiment of the present invention.

### DETAILED DESCRIPTION OF THE INVENTION

For further illustrating the means and functions by which the present invention achieves the certain objectives, the following description, in conjunction with the accompanying drawings and preferred embodiments, is set forth as below to illustrate the implement, structure, features and effects of the subject matter of the present invention.

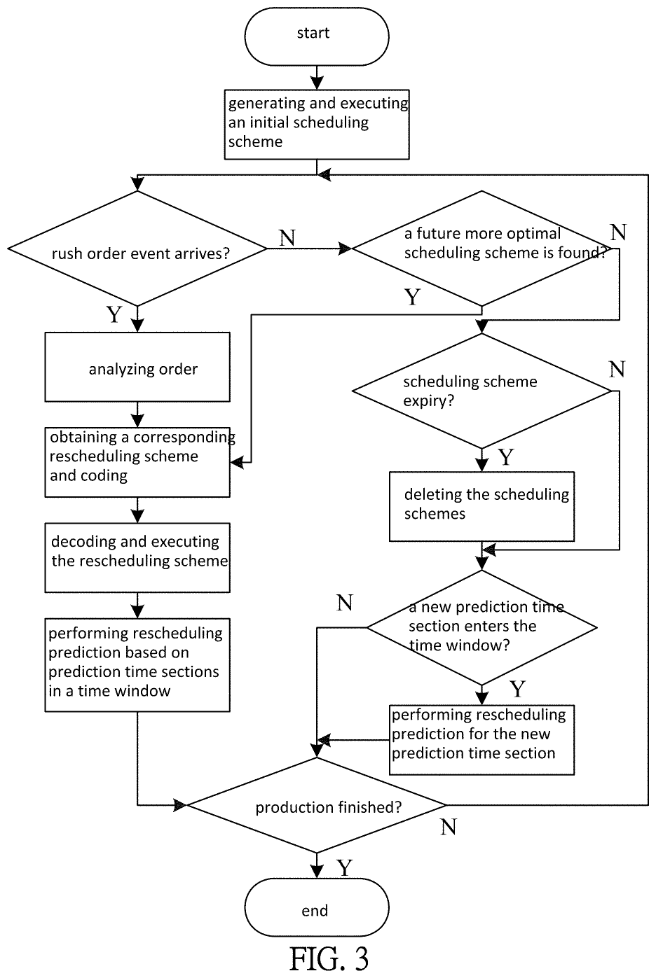

As shown in FIG. 3, in one embodiment of the present invention, a method for prediction of dynamic rescheduling with a digital twin workshop for circuit breakers comprises the following steps S1 through S3:

Step S1 is about performing multi-granularity mapping, movement control and scene optimization on a circuit breaker workshop, and building a circuit breaker digital manufacturing twin workshop system.

Specifically, the circuit breaker manufacturing workshop includes objects like robots, unit boxes, logistics system, and products, and uses robots that have multi-function end-effectors as well as their control system to install components of a circuit breaker into a corresponding circuit breaker housing, thereby achieving flexible, batch-basis assembling production for small circuit breakers of diverse models. Since rescheduling prediction requires real-time data of the workshop, a corresponding circuit breaker digital twin workshop system needs to be built.

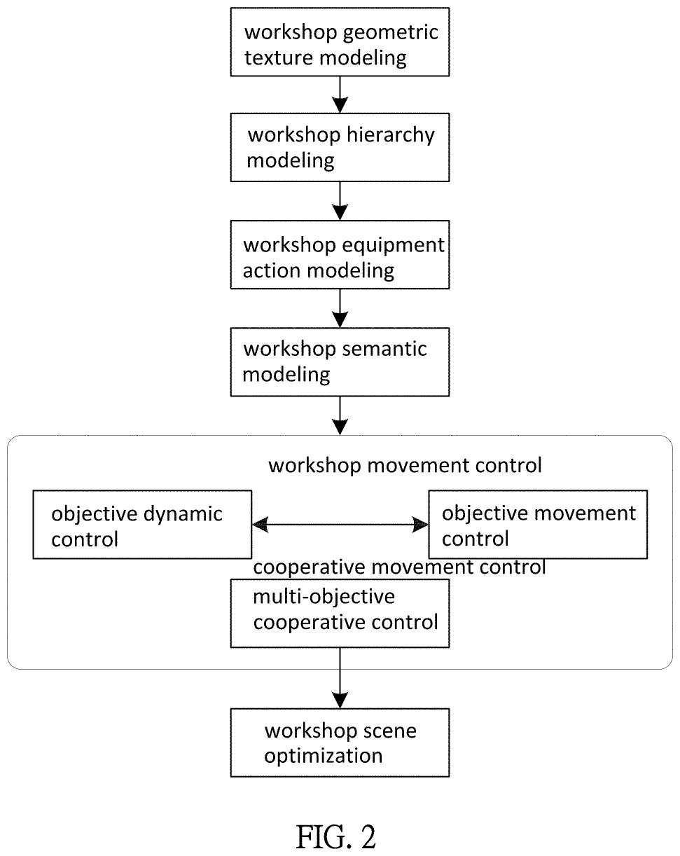

The circuit breaker digital manufacturing twin workshop system is built by performing multi-granularity mapping, movement control and scene optimization on a circuit breaker workshop. Specifically, workshop geometric texture modeling, workshop hierarchy modeling, workshop equipment action modeling, workshop semantic modeling, workshop movement control and workshop scene optimization for the circuit breaker workshop are performed, as shown in FIG. 2. In the circuit breaker digital manufacturing twin workshop system, an operator can check the real-time virtual assembling operations mapped from the actual workshop through a human-computer interaction device, and can be timely informed with equipment operation state, planned assembly works, plan achievement rate, overall equipment effectiveness, equipment energy consumption and more information with the assistance of the data dashboard. It is to be noted that the twin data of the circuit twin workshop is the basic driving signal to dynamic rescheduling.

Step S2 involves determining a circuit breaker workshop dynamic rescheduling mathematical model that is based on rush order events, predicting times and contents of the rush order events according to real-time twin data provided by the circuit breaker digital manufacturing twin workshop system based on a prediction mechanism that relies on time window setting and order inquiry, and further updating the circuit breaker workshop dynamic rescheduling mathematical model with the predicted times and content of the rush order events.

Specifically, on the basis of the digital twin workshop, for achieving rescheduling according to prediction of dynamic rush order events, a dynamic rescheduling mathematical model is designed and focused on rush order events that are likely to happen during workshop production. The circuit breaker workshop dynamic rescheduling mathematical model is generated through automatic update based on a predefined circuit breaker workshop production dynamic scheduling rule.

As shown in FIG. 3, the circuit breaker workshop production dynamic scheduling rule includes: generating and executing an initial scheduling scheme first, if one said rush order event arrives or a future more optimal scheduling scheme is found, decoding and executing a corresponding rescheduling scheme, and further re-performing rescheduling prediction; and if no said rush order events arrive or no future more optimal scheduling schemes are found, performing corresponding rescheduling prediction based on variation of prediction time sections in a time window, until production operation in the workshop stops. For this purpose, the term scheduling scheme expiry refers to a situation where the time of a rush order event predicted in a prediction scheme is earlier than the current time in the workshop, making the scheme useless. Herein, rather than directly executing the scheduling scheme produced in the optimization process of the algorithm, the invention decodes a rescheduling scheme according to the time the corresponding rush order event happens and then executes it. This is because there is likely difference between the predicted rush order event time and the actual rush order event time.

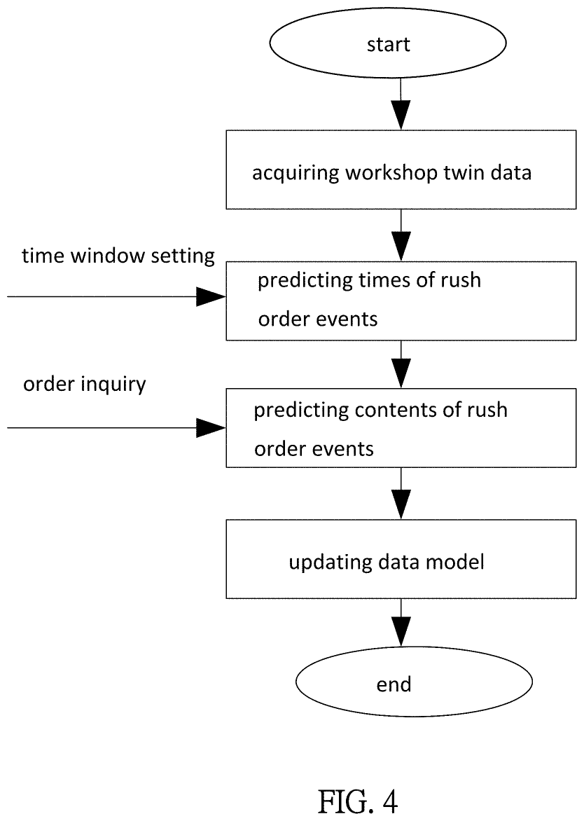

Secondary, for performing workshop rescheduling prediction on the basis of the twin data, a rescheduling prediction mechanism as shown in FIG. 4 is provided to execute the corresponding rescheduling prediction and includes the following steps.

Rescheduling prediction is begun with acquiring the twin data. The prediction is made for rush order events in terms of time and content using time window setting and order inquiry, respectively. Then the circuit breaker workshop dynamic rescheduling mathematical model is updated with the predicted times and contents of rush order events. Therein, the prediction of rush order event times is achieved based on time window setting and the prediction of rush order event contents is achieved based on order inquiry.

It is to be noted that the time window setting is achieved by: dividing operation time of the circuit breaker workshop into plural prediction time sections, and acquiring all the prediction time sections in a given future time period during real-time operation for production of the circuit breakers as times at which dynamic rush order events happen. Order inquiry is achieved by: checking all normal order events that are likely to cut in in the future, generating n+1 states including a “no new order cut in” state and “new order cut in” states for new orders J₁˜Jₙ, in which the no new order cut in state is for real-time optimization of subsequent production operation in the workshop when there is an absence of said rush orders, and the new order cut in state is for optimization prediction of the rescheduling scheme after each said order event cuts in.

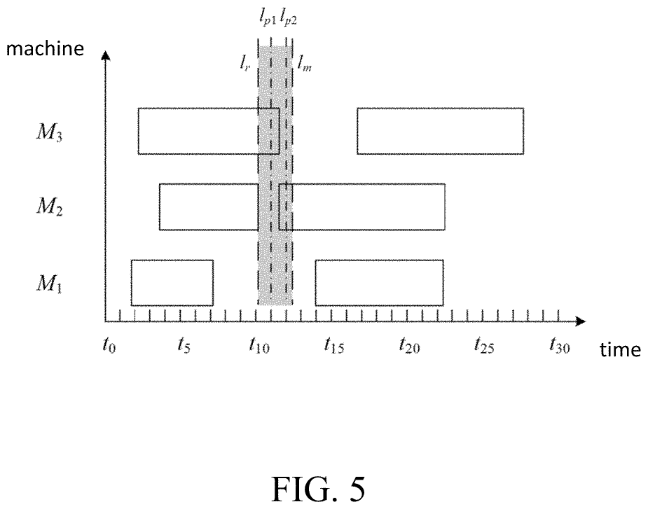

As shown in FIG. 5, in the time prediction method based on time window setting, prediction is made for rush order times of the circuit breaker workshop. Assuming that there are three machines M₁˜M₃ participating in production, plural prediction time sections t₀˜t₃₀, plural processes, the current timeline lᵣ, the upper threshold timeline lₘ of the time window, the timelines lₚ₁, lₚ₂ corresponding to the predicted time sections and the time window denoted by the green area in the drawing are considered and defined below:

1) The prediction time sections t₀˜t₃₀ refer to time sections for the purpose of predicting the times on which rush order events will happen, and the difference Δt between the adjacent time sections has influence on prediction accuracy, computer load and algorithm solution quality;

2) The current timeline lᵣ is a line corresponding to the current time of the workshop;

3) The timeline lₘ is a timeline set for the purpose of predicting the times on which rush order events will happen, and the area between lᵣ and lₘ defines a time window for prediction, wherein rescheduling prediction has to cover all the prediction time sections in the time window when prediction scheduling is performed; and

4) lₚ₁ and lₚ₂ represent two timelines corresponding to the two prediction time sections in the time window, respectively, and the scheduling platform uses the time sections tₚ₁ and tₚ₂ corresponding to the two timelines as the approximate time sections of dynamic events, thereby performing relevant prediction calculation.

Therefore, by identifying the prediction time sections in the time window as the times on which dynamic rush order events happen, the present invention achieves time prediction of rush order events.

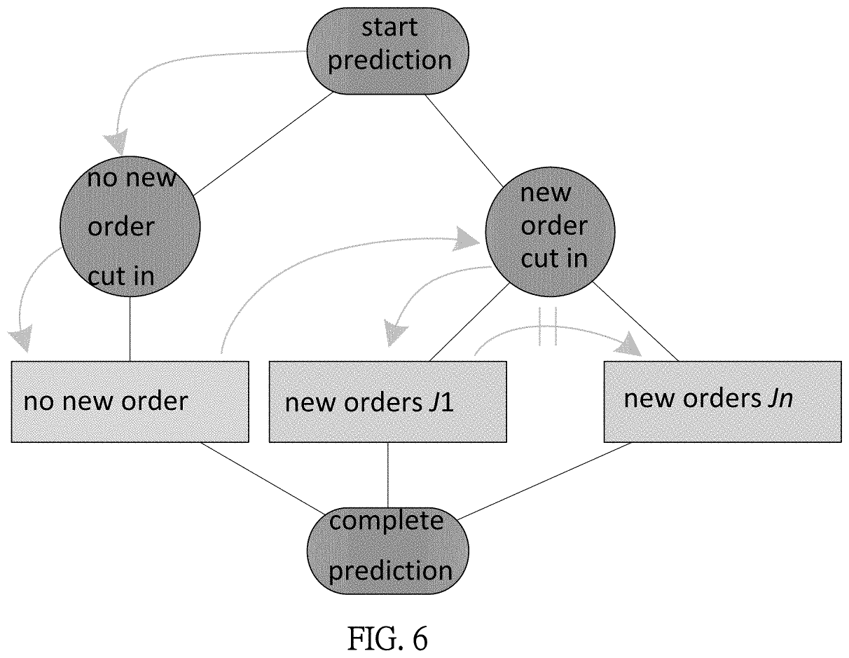

As shown in FIG. 6, prediction of rush order contents is made using the content prediction method based on order inquiry. The order inquiry is mainly based on the characteristic of order variation of in the workshop that when the content difference between orders is relatively small, the information contained therein such as workpiece model and product quantity is relatively fixed. Order inquiry is achieved by: checking all normal order events that are likely to cut in the future, generating n+1 states including a “no new order cut in” state and “new order cut in” states for new orders J₁˜Jₙ, in which the no new order cut in state is for real-time optimization of subsequent production operation in the workshop when there is an absence of said rush orders, and the new order cut in state is for optimization prediction of the rescheduling scheme after each said order event cuts in.

Step S3 includes based on the updated circuit breaker workshop dynamic rescheduling mathematical model, using a multi-objective backtracking optimization algorithm, together with a random key encoding and plug-in decoding method, efficiently finding a solution to the circuit breaker workshop dynamic rescheduling mathematical model in a distributed computing platform, thereby obtaining an optimal dynamic rescheduling prediction scheme. Specifically, performing rescheduling prediction according to the real-time state of the workshop and the dynamic order variation is essentially finding optimization solutions of process distribution and process sequencing. Further, on this basis, the start time and end time of each process on each robot unit are acquired through decoding in order to obtain an operation-scheduling scheme for the real-world workshop. Thus, based on the updated circuit breaker workshop dynamic rescheduling mathematical model, a workshop dynamic rescheduling prediction model for multi-objective optimization focused on production efficiency and equipment energy consumption can be developed, and then solutions to the questions of dynamic rescheduling prediction are found using a multi-objective backtracking optimization algorithm, including five steps, namely Population Initialization, Selection I, Mutation, Crossover and Selection II, which are explained below.

(1) Population Initialization

First, population initialization is performed to acquire the historical population oldP and the current population P. Therein, the historical population is a population used to determine the search direction of every iterative evolution process and is for accomplishing backtracking operation, thereby improving global convergence performance of the algorithm. The current population is the real-time population during iterations for the algorithm. Optimization search of scheduling schemes for the small circuit breaker flexible operation workshop is achieved through operations of crossover, mutation and selection, and memory of the quality small circuit breaker flexible operation-scheduling scheme is achieved using an elite retention strategy. The method of population initialization may be represented by:

P_{r,s}˜U(lowₛ,upₛ) (1)

oldP_{r,s}˜U(lowₛ,upₛ) (2)

Formulas (1) and (2) satisfy r=1, 2, 3, . . . , R and s=1, 2, 3, . . . , S, and in the prediction questions of the rescheduling method for the small circuit breaker flexible operation workshop, R represents the population scale, S represents the number of processes to be scheduled in the workshop; lowₛ and upₛ represent the upper boundary and lower boundary of coding of the s^{th} processes, and satisfy lowₛ=0, upₛ=1; U represents the uniform distribution function. Therein, coding of populations and individuals in the historical population is made using the random key method, thereby providing two-segment codes corresponding to process sequencing and process assignment of workshop scheduling.

(2) Selection I

The selection I operator is mainly used to determine the population oldP for every iteration process. There are two steps. The first one is to perform backtracking operation by comparing random numbers and the second one is to enhance global convergence of the algorithm by randomly disturbing the historical population. The selection I operator may be represented by:

$$\begin{matrix}\{ \begin{matrix}oldP := P , a < b \\ oldP := oldP , a \geq b\end{matrix} & ( 3 ) \\ oldP := permutting ( oldP ) & ( 4 )\end{matrix}$$

where “:=” is assignment operation; a and b are two random variables following U(0,1) uniform distribution; and permutting is the random shuffle function, for randomly disturbing the sequence of coding of each flexible operation workshop scheduling scheme in the historical population.

(3) Mutation

The mutation operator is mainly used to generate the initial form of the experimental population T, and includes mutation of process assignment and process sequencing, respectively, being represented by:

Mutant=P+F·(oldP˜P) (5)

where F=3·rndn is the amplitude control function for the direction decision matrix (oldP−P), and rndn is a random number following the standard normal distribution.

(4) Crossover

The crossover operator is mainly used to generate the final form of the experimental population T, and the initial form of the experimental population T is Mutant generated by the mutation operator. The crossover operator relates to two steps, wherein the first step is to build a binary integer mapped matrix map having a dimension of R×S, and the mapped matrix map is calculated by:

$$\begin{matrix}{map}_{1 : R , 1 : S} = 1 & ( 6 ) \\ \{ \begin{matrix}{map}_{r , i ( 1 : ⌈ mixrate \cdot rnd \cdot S ⌉ )} = 0 , a < b \\ {map}_{r , randi ( S )} = 0 , a \geq b\end{matrix} & ( 7 )\end{matrix}$$

where a and b are random numbers following U(0,1) distribution; mixrate is the crossover probability, also the only optimizing parameter in the algorithm that needs to be set, and the choice may be mixrate=1; randi(D) represents the random integer-valued function uniformly distributed on [0,D]. u=permutting(<1, 2, 3, . . . , D>) is an integer vector for random sequencing.

The second step is to complete the building of the experimental population T using the mapped matrix map as the guide. Then process assignment codes and process sequencing codes of the individuals P_{i,j} of the current population and Mutant are selectively mapped to the individuals in the experimental population using Equation (8), and the search space is defined using the boundary control strategy of Equation (9). This is represented by:

$$\begin{matrix}{T}_{r , s} = \{ \begin{matrix}{P}_{r , s} , {map}_{r , s} = 1 \\ Mutant , {map}_{r , s = 0}\end{matrix} & ( 8 ) \\ {T}_{r , s} = \{ \begin{matrix}{T}_{r , s} , {low}_{s} \leq {T}_{r , s} \leq {up}_{s} \\ rnd \cdot ( {up}_{s} - {low}_{s} ) + {low}_{s} , else\end{matrix} & ( 9 )\end{matrix}$$

Therein, Equation (8) is for completing the building of the experimental population T, and Equation (9) is for setting the search boundary for the process assignment random key and the process sequencing random key. Rnd is a random number following U(0,1) uniform distribution.

(5) Selection II

In the part of selection II operator, the individuals in the current population P and in the experimental population T are compared using the weighted objective function (i.e. makespan and equipment energy consumption), thereby achieving multi-objective optimization scheduling for the small circuit breaker flexible operation workshop. Meanwhile, the selection II operator uses the elite retention strategy to memorize quality individuals. It may be represented by:

$$\{ \begin{matrix}{P}_{r} : {T}_{r} , F ( {P}_{r} ) > F ( {T}_{r} ) \\ {P}_{r} := {P}_{r} , F ( {P}_{r} ) \leq F ( {T}_{r} )\end{matrix} \qquad ( 10 )$$

Therein, Pᵣ represents the r^{th} individual of the current population P, Tᵣ represents the r^{th} individual of the experimental population T, and F represents the weighted objective function calculated using Equation (11). Meanwhile, Equation (12) represents the calculation method for makespan of the workshop scheduling scheme; Equation (13) represents the calculation method for equipment energy consumption of the workshop scheduling scheme; and Equation (14) represents the calculation method for idle times of the machines. In these equations, β₁ and β₂ represent the weight coefficients of the objective function; Dᵢₕⱼₖ represents the time on which the process Qᵢₕⱼ ends on the machine k; Uₖ represents the idle power of the robot Mₖ; Xᵢₕⱼₖ is a 0-1 variable, and of the circuit breaker process Qᵢₕⱼ is assigned to the robot k, Xᵢₕⱼₖ=1; otherwise Xᵢₕⱼₖ=0; Tᵢⱼₖ is the working time of the processes j for the circuit breaker I on the machine k; Nᵢ is the number of the circuit breakers corresponding to each batch of the circuit breaker Jᵢ; SMₖ represents machine Mₖ is the earliest time on which the work starts, and is determined by the workshop twin data; Bᵢ represents the total number of batches of the circuit breaker Jᵢ; and SPᵢₕ and EPᵢₕ are the start process number and the end process number of the batch Hᵢₕ.

$$\begin{matrix} F = min ( {β}_{1} \times {f}_{1} + {β}_{2} \times {f}_{2} ) , {β}_{1} , {β}_{2} ∈ ( 0 , 1 ) & ( 11 ) \\ {f}_{1} = {C}_{max} = max \{ {D}_{ihjk} \vert ∀ i , h , j , k \} & ( 12 ) \\ {f}_{2} = E = \frac{{\sum }_{k = 1}^{m} {IT}_{k} \times {U}_{k} + {\sum }_{i = 1}^{n} {\sum }_{h = 1}^{{B}_{i}} {\sum }_{j = {SP}_{ih}}^{{EP}_{ih}} {\sum }_{k = 1}^{m} {X}_{ithjk} \times {T}_{ijk} \times {P}_{ijk} \times {N}_{i}}{3600} & ( 13 ) \\ {IT}_{k} = {C}_{max} - {SM}_{k} - {\sum }_{i = 1}^{n} {\sum }_{h = 1}^{{B}_{i}} {\sum }_{j = {SP}_{ih}}^{{EP}_{ih}} {X}_{ihjk} \times {T}_{ijk} \times {N}_{i} & ( 14 )\end{matrix}$$

For the calculation of Equations (11)-(14), the scheduling scheme for the circuit breaker workshop has to be decoded in order to acquire the operation-scheduling scheme of the real-world workshop.

In the embodiment of the present invention, the plug-in decoding method for operation workshop scheduling is used directly to decode process sequencing and process assignment. After process assignment and process sequencing are acquired, the questions are decoded to acquire the final workshop operation-scheduling scheme. Plug-in decoding is performed through steps of: acquiring processes corresponding to process sequencing one by one, and inserting them into the first feasible interval on the robot unit according to the process assignment scheme; if there is not a feasible interval, inserting the processes after the end time section of the last process that has been assigned to the machine.

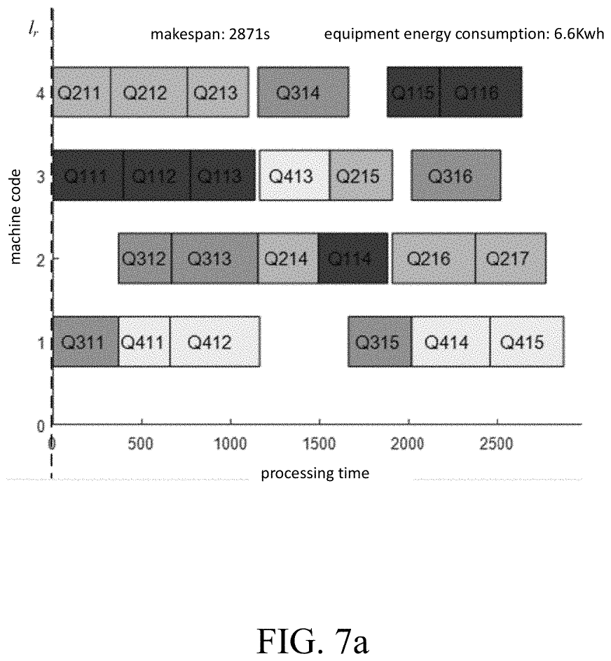

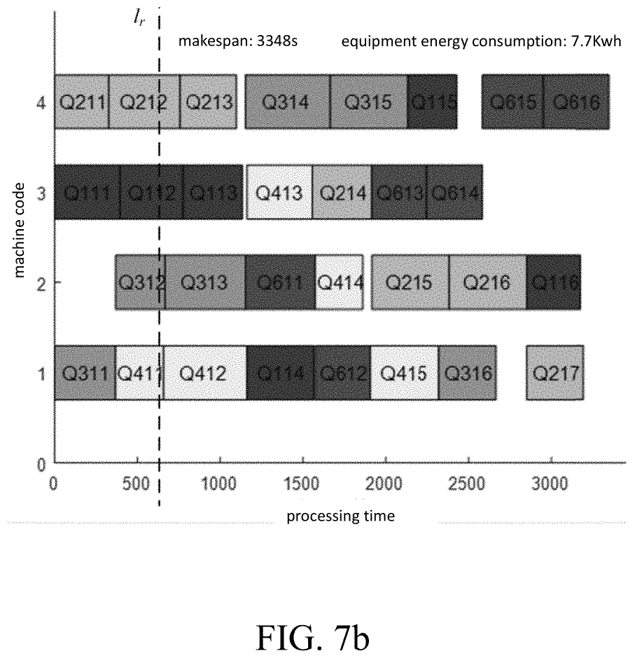

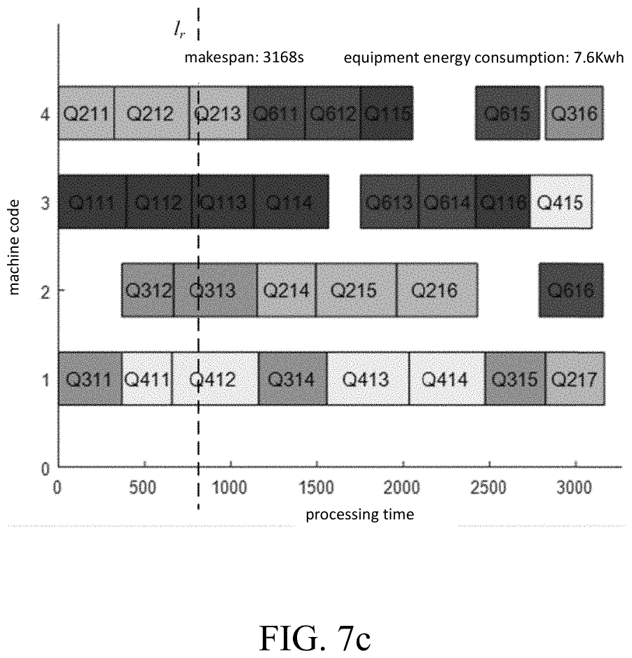

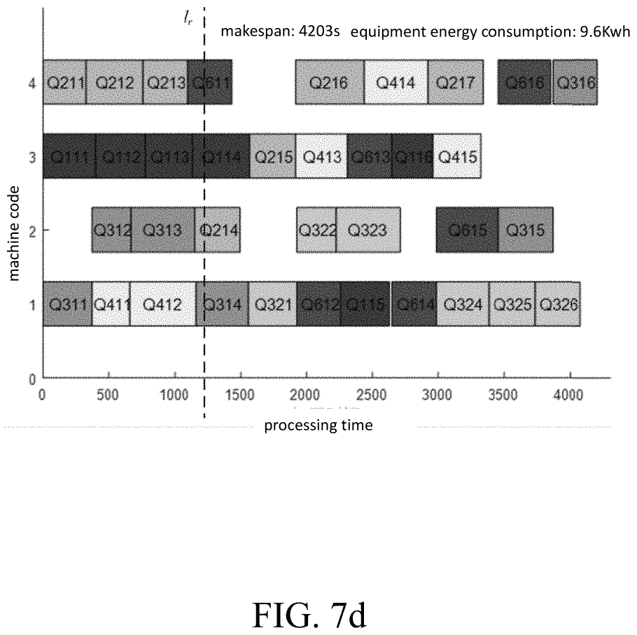

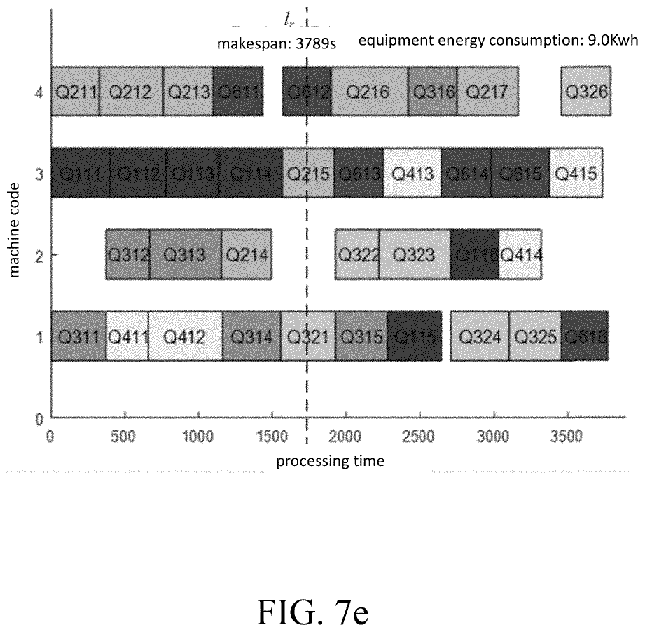

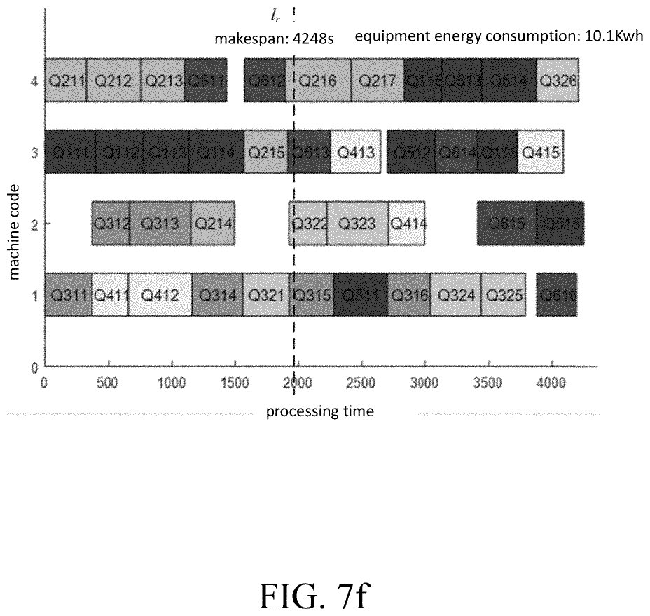

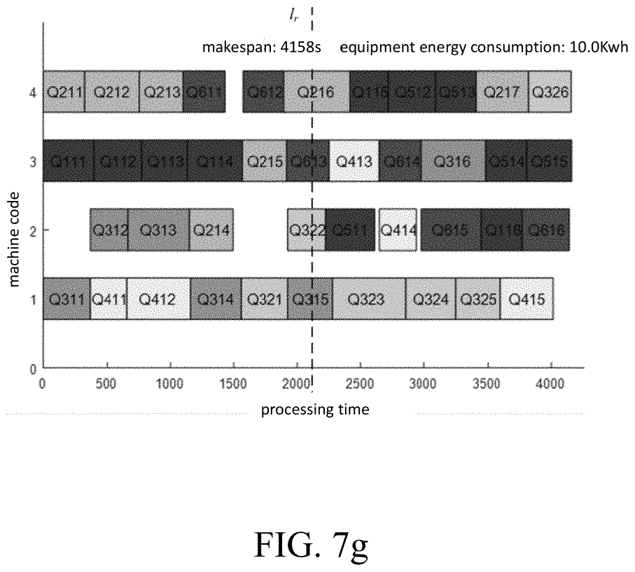

As shown in FIG. 7a-FIG. 7g, the method for prediction of dynamic rescheduling with a digital twin workshop for circuit breakers of the embodiment of the present invention was applied to practical workshop operation, and parallel optimization was performed under the concept of distributed calculation, by means of plural lower machines, thereby further enhancing efficiency of dynamic rescheduling prediction for the circuit breaker digital manufacturing twin workshop.

The following parameters were set: the number of batches of the circuit breakers Nᵢ, operation time Tᵢⱼₖ, operation power Pᵢⱼₖ, robot idle power Uₖ, algorithm crossover rate, algorithm mutation rate, population size, weight coefficients β₁/β₂, time window length, and prediction time interval.

In the initial time section during the workshop experiment, the state of the production orders of the workshop was: 4 robots M₁˜M₄, and 4 types of circuit breakers J₁˜J₄, one batch for each. With the progress of the workshop operation, the following events happened in the workshop:

1) In the time section t=0s, the workshop generated and executed the initial scheduling scheme as shown in FIG. 7a;

2) In the time section t=645s, an order for the circuit breaker J₆ cut in, and the rescheduling scheme as shown in FIG. 7b was executed in a real-time manner;

3) In the time section t=832s, the scheduling platform found a more optimal scheduling operation scheme, and the rescheduling scheme as shown in FIG. 7c was executed in a real-time manner;

4) In the time section t=1246s, an order for the circuit breaker J₃ cut in, and the rescheduling scheme as shown in FIG. 7d was executed in a real-time manner;

5) In the time section t=1572s, the scheduling platform found a more optimal scheduling operation scheme, and the rescheduling scheme as shown in FIG. 7e was executed in a real-time manner;

6) In the time section t=1985s, an order for the circuit breaker J₅ cut in, and the rescheduling scheme as shown in FIG. 7f was executed in a real-time manner;

7) In the time section t=2179s, the scheduling platform found a more optimal scheduling operation scheme, and the rescheduling scheme as shown in FIG. 7g was executed in a real-time manner.

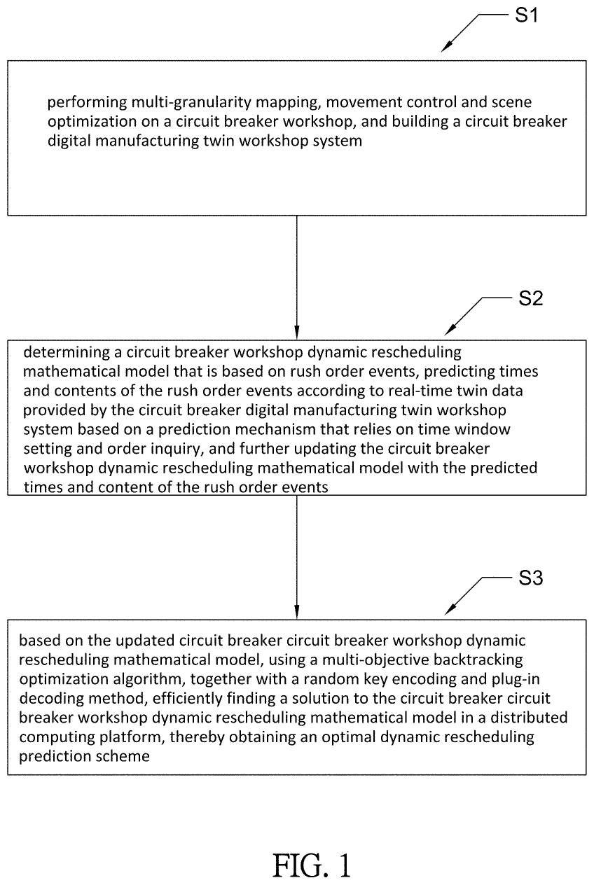

The more optimal rescheduling schemes in response to the rush order events were generated and executed according to the workshop production scheduling rule as shown in FIG. 1. Records made during this process reflect: the rescheduling response time for the process of FIG. 7b is 62.4 ms; the rescheduling response time for the process of FIG. 7c is 17.2 ms; the rescheduling response time for the process of FIG. 7d is 71.7 ms; the rescheduling response time for the process of FIG. 7e is 19.8 ms; the rescheduling response time for the process of FIG. 7f is 69.6 ms; and the rescheduling response time for the process of FIG. 7g is 18.1 ms. It is thus clear that the disclosed rescheduling prediction method can fast and effectively respond to dynamic rush order events within ignorable tens of microseconds.

The makespan of the circuit breaker operation workshop scheduling scheme calculated using the dynamic rescheduling method is 5130s, and the equipment energy consumption is 10.9 kwh. By comparison, the makespan of the operation workshop scheduling scheme for the workshop calculated using the traditional cycle-based rescheduling method is 4158s, and the equipment energy consumption is 10.0 kwh. The dynamic rescheduling prediction method provides fast and effective rescheduling decision and continuously optimizes the current scheduling scheme to decrease the makespan by 18.9% and reduce the equipment energy consumption by 9.0%.

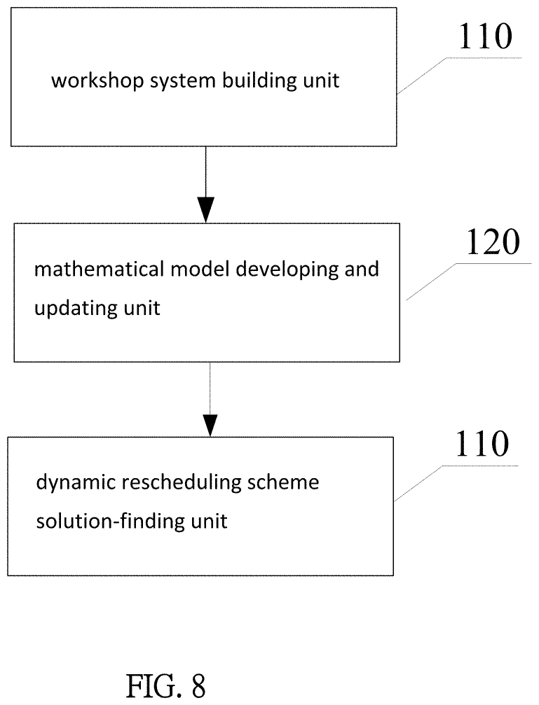

As shown in FIG. 8, in one embodiment of the present invention, a system for prediction of dynamic rescheduling with a digital twin workshop for circuit breakers comprises a workshop system building unit 110, a mathematical model developing and updating unit 120, and a dynamic rescheduling scheme solution-finding unit 130.

The workshop system building unit 110 serves to perform multi-granularity mapping, movement control and scene optimization on a circuit breaker workshop, and build a circuit breaker digital manufacturing twin workshop system.

The mathematical model developing and updating unit 120 serves to determine a circuit breaker workshop dynamic rescheduling mathematical model based on rush order events, to predict times and contents of the rush order events according to real-time twin data provided by the circuit breaker digital manufacturing twin workshop system based on a time window setting and a prediction mechanism for order inquiry, and to further update the circuit breaker workshop dynamic rescheduling mathematical model according to the predicted times and contents of the rush order events.

The dynamic rescheduling scheme solution-finding unit 130 serves to efficiently find a solution to the circuit breaker workshop dynamic rescheduling mathematical model in a distributed computing platform based on the updated circuit breaker workshop dynamic rescheduling mathematical model, using a multi-objective backtracking optimization algorithm, together with a random key encoding and plug-in decoding method, thereby obtaining an optimal dynamic rescheduling prediction scheme.

Therein, the circuit breaker workshop dynamic rescheduling mathematical model based on the rush order events is generated through automatic update based on a predefined circuit breaker workshop production dynamic scheduling rule.

Therein, the times of the rush order events are predicted based on time window setting and the contents of the rush order events are predicted based on an order inquiry.

By implementing embodiments of the present invention, the following beneficial effects are expected:

The present invention uses a workshop rescheduling prediction mechanism based on time window setting and order inquiry to predict times and contents of dynamic rush order events that are likely to happen in the future, and employs a proactive method to deal with rush order events by performing dynamic rescheduling prediction of the circuit breaker digital manufacturing twin workshop, for more efficient rescheduling in a circuit breaker workshop as response to dynamic rush order events, thereby optimizing production.

It is to be noted that, in the foregoing embodiment of the system, the incorporated individual system units are divided by functional logic, but they may be divided otherwise as long as they are allowed to function as intended. Additionally, the designations assigned to these functional units are only for distinguishability, but not intended to limit the scope of the present invention.

People of ordinary skill in the art should understand that the method as described in the foregoing embodiment may be entirely or partially implemented by using a program to instruct related hardware, and the program may be stored in a computer-readable storage medium, such as a ROM/RAM, a magnetic disk or an optical disk.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims

What is claimed is:

1. A method for prediction of dynamic rescheduling with a digital twin workshop for circuit breakers, the method comprising steps of:
Step S1: performing multi-granularity mapping, movement control and scene optimization on a circuit breaker workshop, and building a circuit breaker digital manufacturing twin workshop system;
Step S2: determining a circuit breaker workshop dynamic rescheduling mathematical model that is based on rush order events, predicting times and contents of the rush order events according to real-time twin data provided by the circuit breaker digital manufacturing twin workshop system based on a prediction mechanism that relies on time window setting and order inquiry, and further updating the circuit breaker workshop dynamic rescheduling mathematical model with the predicted times and content of the rush order events; and
Step S3: based on the updated circuit breaker circuit breaker workshop dynamic rescheduling mathematical model, using a multi-objective backtracking optimization algorithm, together with a random key encoding and plug-in decoding method, efficiently finding a solution to the circuit breaker circuit breaker workshop dynamic rescheduling mathematical model in a distributed computing platform, thereby obtaining an optimal dynamic rescheduling prediction scheme.

2. The method of claim 1, wherein the step of performing multi-granularity mapping, movement control and scene optimization on a circuit breaker workshop is achieved by:
performing workshop geometric texture modeling, workshop hierarchy modeling, workshop equipment action modeling, workshop semantic modeling, workshop movement control and workshop scene optimization for the circuit breaker workshop.

3. The method of claim 1, wherein the circuit breaker workshop dynamic rescheduling mathematical model based on the rush order events is generated through automatic update based on a predefined circuit breaker workshop production dynamic scheduling rule, in which
the circuit breaker workshop production dynamic scheduling rule includes: generating and executing an initial scheduling scheme first, if one said rush order event arrives or a future more optimal scheduling scheme is found, decoding and executing a corresponding rescheduling scheme, and further re-performing rescheduling prediction; and if no said rush order events arrive or no future more optimal scheduling schemes are found, performing corresponding rescheduling prediction based on variation of prediction time sections in a time window, until production operation in the workshop stops.

4. The method of claim 1, wherein the times of the rush order events are predicted based on the time window setting, and the contents of the rush order events are predicted based on the order inquiry.

5. The method of claim 4, wherein the time window setting is achieved by:
dividing operation time of the circuit breaker workshop into plural prediction time sections, and acquiring all the prediction time sections in a given future time period during real-time operation for production of the circuit breakers as times at which dynamic rush order events happen.

6. The method of claim 4, wherein the order inquiry is achieved by:
checking all normal order events that are likely to cut in in the future, generating n+1 states including a “no new order cut in” state and “new order cut in” states for new orders J₁˜Jₙ, in which the no new order cut in state is for real-time optimization of subsequent production operation in the workshop when there is an absence of said rush orders, and the new order cut in state is for optimization prediction of the rescheduling scheme after each said order event cuts in.

7. A system for prediction of dynamic rescheduling with a digital twin workshop for circuit breakers, the system comprising a workshop system building unit, a mathematical model developing and updating unit, and a dynamic rescheduling scheme solution-finding unit,
the workshop system building unit, serving to perform multi-granularity mapping, movement control and scene optimization on a circuit breaker workshop, and building a circuit breaker digital manufacturing twin workshop system;
the mathematical model developing and updating unit, serving to determine a circuit breaker workshop dynamic rescheduling mathematical model based on rush order events, to predict times and contents of the rush order events according to real-time twin data provided by the circuit breaker digital manufacturing twin workshop system based on a prediction mechanism that relies on time window setting and order inquiry, and to further update the circuit breaker workshop dynamic rescheduling mathematical model according to the predicted times and contents of the rush order events; and
the dynamic rescheduling scheme solution-finding unit, serving to efficiently find a solution to the circuit breaker workshop dynamic rescheduling mathematical model in a distributed computing platform based on the updated circuit breaker workshop dynamic rescheduling mathematical model, using a multi-objective backtracking optimization algorithm, together with a random key encoding and plug-in decoding method, thereby obtaining an optimal dynamic rescheduling prediction scheme.

8. The system of claim 7, wherein the circuit breaker workshop dynamic rescheduling mathematical model based on the rush order events is generated through automatic update based on a predefined circuit breaker workshop production dynamic scheduling rule.

9. The system of claim 8, wherein the times of the rush order events are predicted based on the time window setting, and the contents of the rush order events are predicted based on the order inquiry.
